(19) United States
(12) Patent Application Publication
(10) Pub. No.: US 2014/0278357 A1
(43) Pub. Date: Sep. 18, 2014

(54) WORD GENERATION AND SCORING USING SUB-WORD SEGMENTS AND CHARACTERISTIC OF INTEREST

(71) Applicant: Reverb Technologies, Inc., San Mateo, CA (US)

(72) Inventor: Russell Horton, La Jolla, CA (US)

(73) Assignee: Wordnik, Inc., San Mateo, CA (US)

(21) Appl. No.: 13/828,600

(22) Filed: Mar. 14, 2013

(51) Int. Cl. G06F 17/28

(52) U.S. Cl. CPC G06F 17/28
USPC 704/9

(57) ABSTRACT

Methods for scoring a word or generating new words according to a characteristic of interest can use a computer system to access a corpus of words exemplifying a characteristic of interest. Each word is broken into a type of subword segments. Each subword segment in the corpus of words has a value score. The word to be scored is broken into the type of sub-word segment and value score for each is determined and is used to create a characteristic of interest score for the word. For generating new words, a number of first subword segments are chosen based at least in part upon value scores. At least one additional subword segment is combined with the first subword segments to create a set of potential new words, a second value score is generated for each, and a new word is selected and provided to a user.

### BACKGROUND

The invention relates using sub-word segments to generate new words and to score existing words based on a characteristic of interest.

A great amount of time and effort goes into selecting a word or generating a new word prior to launching a new product or enterprise. For example, pharmaceutical products typically have three names. The first is the chemical name with all the chemical symbols involved, the second is its generic name, and the third is the trademark, often referred to as the brand name or brand used by the pharmaceutical company. The first name is determined by the chemical structure based upon generally accepted nomenclature rules for naming chemical compounds. The second, generic name is typically established by national or international governing bodies. The pharmaceutical company gets to choose its trademark or brand name which it hopes everyone will remember and use when selecting and using the pharmaceutical product.

Other companies and organizations, such as automobile manufacturers, restaurant chains, electronic manufacturers, digital design studios, and so forth, also take selection of the words or groups of words used in the sale and advertising of its products or services very seriously. Sometimes the success or failure of the launch of a product or service can be determined by the name chosen for the particular product or service. Companies exist for the purpose of coming up with suitable words, whether they are existing words or made-up words, together with how they artistically rendered, that convey a desired image. The choice of a name for a new product or service, as well as the choice of a new name for existing product or service can be critical to the success of the product or service.

### SUMMARY

A method for scoring a word according to a characteristic of interest can use a computer system to access a corpus of words exemplifying a characteristic of interest. Each word in the corpus of words is broken into sub-word segments of a first type of sub-word segments. The number of times each sub-word segment is found in the corpus of words is stored as a first set of results. Each sub-word segment has an associated value score based at least in part on the occurrence of the sub-word segment in the corpus of words. The value scores are stored as a second set of results. A word to be scored is broken into the first type of sub-word segments. The value score for each of the sub-word segments of the word to be scored is determined based upon the second set of results. The value scores for each of the sub-word segments of the word to be scored are used to create a characteristic of interest score for the word to be scored. A user is provided a word having an appropriate characteristic of interest score for use.

Some examples of the word scoring method can include one or more the following. A corpus of words exemplifying typicality as the characteristic of interest can be accessed. The corpus of words can be broken into at least one n-gram type of sub-word segments. The associated value score can be a probability score. The method can include naming a product using a provided word having an appropriate characteristic of interest score. The method can include applying the provided word to at least one of the product, packaging associated with the product.

A method for generating new words according to a characteristic of interest can use a computer system to access a corpus of words exemplifying a characteristic of interest. Each word in the corpus of words is broken into sub-word segments of a first type of sub-word segments. The number of times each sub-word segment is found in the corpus of words is stored as a first set of results. Each sub-word segment has an associated value score based at least in part on the occurrence of the sub-word segment in the corpus of words. The value scores are stored as a second set of results. A number of first sub-word segments are chosen based at least in part upon their value scores. At least one additional sub-word segment is combined with the first sub-word segments based at least in part upon the first value scores for the at least one additional sub-word segments to create a set of potential new words. A second value score is generated for each of the potential new words. A new word is selected from the potential new words based at least in part on the second value scores. The new word is provided to a user for use.

Some examples of the word generating method can include one or more the following. A corpus of words exemplifying typicality as the characteristic of interest can be accessed. A corpus of words in which the words have been broken into at least one n-gram type of sub-word segments can be accessed. The associated value score can be a probability score. The probability scores for the sub-word segments for each of the potential new words can be combined. The probability scores for the sub-word segments for each of the potential new words can be averaged. A product can be named using the new word, and the new word can be applied to at least one of the product, packaging associated with the product.

The above summary of the invention is provided to provide a basic understanding of some aspects of the invention. This summary is not intended to identify key or critical elements of the invention or to delineate the scope of the invention. Its sole purpose is to present some concepts of the invention in a simplified form as a prelude to the more detailed description that is presented later. Particular aspects of the invention are described in the claims, specification and drawings.

### BRIEF DESCRIPTION OF THE DRAWINGS

FIG. 1 is a flow chart indicating general steps for a method for scoring words.

FIG. 2 is a flow chart indicating the general steps for a method for generating new words.

FIG. 3 is a simplified block diagram of a computer system 110 that can be used to implement aspects of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Like elements in different examples are often referred to using like reference numerals.

Broadly speaking, the process of generating new words with desired characteristics, or scoring existing words for the degree to which they exhibit such characteristics, both rely on the ability to score sub-word-level components for those same characteristics. The score for the word as a whole is then derived from the scores of the sub-word segments. This process can be useful in the selection of, for example, new product names, new company names, or new descriptors for rendering services.

In a method for scoring words, see FIG. 1, the type of sub-word segment to be used, see step 10, is chosen. Commonly used sub-word segments include letters or letter sequences based on the word's spelling, or based upon phonemes, or based upon syllables, or based upon other phonetic sequences arrived at by the word's pronunciation. It is also possible to generate different models each using different types of sub-word segments and then combine the scores to generate a single overall score. For sake of simplicity, the following analysis will use a single type of sub-word segment. In this example, the type of sub-word segment used will be n-grams of letters from the word. An n-gram is a sequence of characters, in order, with n denoting the length of the sequence. Additionally, the beginning and end of the word as considered as distinct characters, which will be denoted with ̂ and $ respectively.

In this way, the word “glimmer” consists of seven 3-grams: ̂gl, gli, lim, imm, mme, mer, er$.

The same word consists of only three 7-grams: ̂glimme, glimmer, limmer$.

A characteristic of interest must be selected as indicated at step 12 of FIG. 1. Assume the task is to generate new words that fit one criterion—they sound like good, normal words of English. Or to put it another way, the task is to score words for how typical of English words they appear to be. In this example the characteristic of interest will sometimes be referred to as typicality.

In addition, a corpus of words exemplifying the selected characteristic of interest, see step 14 of FIG. 1, must be accessed. In this example the words from one or more standard English language dictionaries could constitute the corpus of words.

Each word in the corpus of words is broken into one or more n-gram type of sub-word segments. See step 16. For example, each of the words in the corpus of words can be broken into 3-gram words, 4-gram words, 5-gram words and 7-gram words.

Thereafter, see step 18, the total number of times each n-gram is found in the corpus of words is determined and the results are stored as a first set of results. This is done by counting how often individual n-grams occur in the corpus of words. Next, a value score, see step 20, is generated for each n-gram. A common example of a value score is the probability for that n-gram, that is the number of times each n-gram is found in the corpus of words divided by the total number of n-grams in the corpus of words. One way to determine the probability of each n-gram is to walk through the corpus of words, also referred to as the word list, and turn each word into n-grams. Each time an n-gram is encountered, its count is incremented and stored in the first set of results. When the evaluation is done, a list of all the n-grams in the corpus of words has been generated and the number of times each n-gram has occurred has been recorded.

Next, the word being scored is broken into sub-word segments, see step 22, in this example n-grams. The value score, probability in this example, for each n-gram of the word being scored is determined at step 24. A characteristic of interest score, see step 26, for the word being scored is created from the value scores for each n-gram of the word being scored. When the value score is probability, the characteristic of interest score for the word being scored is the probability of each of those n-grams occurring together. This is commonly determined by multiplying each of the individual probabilities for each n-gram together. The higher the probability, the more typical that word is. To make the results more meaningful, benchmark probabilities for the corpus of words for the particular characteristic of interest can be provided to the user. One way to create benchmark probabilities is to run the scoring process over a list of words that are perceived to exhibit the characteristic to greater or lesser degrees. For English word typicality, for example, such a list might include “incantation”, a very typical word, at one end of the scale, and “syzygy”, a high untypical word, at the other end. In this way users can compare the scores for new words to those for familiar words.

At step 28, those words having an appropriate characteristic of interest score can be provided for use in the selection of, for example, a new name, such as a product name, a company name, or a name for services to be rendered. The provision of the word or words having an appropriate characteristic of interest score can be for example, by one or more of: displaying the word or words on a display screen, printing out a hard copy, saving an electronic copy for later retrieval, and transmitting the word or words to one or more destinations. For example, the five words with the highest characteristic of interest scores could be provided as an email survey to a cross-section of potential purchasers to get their reaction on the strength and suitability of each word. The results of the survey could be used in making the final selection. The finally selected word can be used, for example, alone or in conjunction with one or more other words; in either case the finally selected word can be displayed using specialized lettering or as a part of a logo including additional artwork, or both. The finally selected word can be used as a trademark or service mark, as part of a trademark or service mark, or otherwise. The finally selected word can also be physically applied to a product or printed on packaging. Instead of a new name, the process can be used to find a word for other purposes, such as for use in describing a feature of a product in product literature, or for use in describing a special component in an instruction manual, or for use in coming up with a generic name for a new product category. An advantage of proceeding in this way, in contrast with hiring an outside consulting firm to find a new product name, is that the process can be automated with relatively minor amount of input thus potentially substantially reducing cost and time.

When creating the characteristic of interest score for the word being scored, it can be necessary to account for word length in some fashion, or longer words will be penalized simply by having more segments and more probabilities multiplied together. One way of doing so is to show the user a selection of the top-ranking words at each desired word length, for example, 100 words each of length 5, 6, 7 and 8. Alternatively, the probabilities of each n-gram can be averaged, which would have the advantage of not penalizing longer words.

Using this type of word scoring, a word like “incantation”, containing many very common English 3-grams like “ant” and “ion”, will be scored as much more typical than a word like “syzygy”, which contains many unusual letter sequences.

As indicated above, it would be possible to create multiple models in this way, for example by counting 3-grams, 4-grams and 5-grams separately, and then averaging the model scores together. This would typically entail proceeding with steps 10-28 for the first n-gram and then proceeding with steps 16-28 for each additional n-gram. Using pronunciation data instead of orthographic data would proceed similarly—n-grams of phonemes, or perhaps entire syllables, would be counted in some representative corpus of words, and then used to score words for typicality. Spelling-based models could be combined with pronunciation-based models by some weighted average of the various model scores. For example, three separate models for a single word characteristic could be trained on 3-grams of letters, 5-grams of letters, and 3-grams of phonemes. A given word can then be scored separately for each of these of these models, and a synthetic score created by weighting each of the letter-based models 25%, and the phoneme-based model 50%.

N-grams, as well as other types of sub-word segments, are equally capable of generating new words as scoring existing words. FIG. 2 briefly describes the steps for one example of generating new words. Steps 30-40 are the same as steps 10-20 in FIG. 1. Thereafter, see step 42, one or more first sub-word segments are chosen to start the new word. The sub-word segments are typically chosen based at least in part on the value scores, probability being a common example of a value score. Next, one or more second sub-word segments are chosen, see step 44, also typically based at least in part on the value scores. Each of the second sub-word segments is combined with each of the first sub-word segments at step 46. For example, if 3 first sub-word segments were chosen and if 3 second sub-word segments were chosen, the result would be 9 potential new words combining 2 sub-word segments. As indicated at step 48, additional sub-word segments can be chosen and combined with previously generated sub-word segments to create potential new words. After doing this at least twice, a second value score for each of the potential new words is generated, see step 50, and one or more new words from the potential new words can then be selected as indicated at step 52. A user would typically select a new word or words of interest by browsing the selection of new words generated in this process. Because this process preferentially chooses sub-word segments that are maximally associated with the desired word characteristic, the result word lists will also be highly reflective of the word characteristic.

At step 54, the selected word or words can be provided for use in the selection of, for example, a new name, such as a product name, a company name, or a name for services to be rendered. The provision of the selected word or words can be for example, by one or more of: displaying the word or words on a display screen, printing out a hard copy, saving an electronic copy for later retrieval, and transmitting the word or words to one or more destinations. For example, the five selected words could be provided as an email survey to a cross-section of potential purchasers to get their reaction on the strength and suitability of each of the selected words. The results of the survey could be used in making the final selection. The finally selected word can be used, for example, alone or in conjunction with one or more other words; in either case the finally selected word can be displayed using specialized lettering or as a part of a logo including additional artwork, or both. The finally selected word can be used as a trademark or service mark, as part of a trademark or service mark, or otherwise. The finally selected word can also be physically applied to a product or printed on packaging. Instead of a new name, the process can be used to find a word for other purposes, such as for use in describing a feature of a product in product literature, or for use in describing a special component in an instruction manual, or for use in coming up with a generic name for a new product category. An advantage of proceeding in this way, in contrast with hiring an outside consulting firm to create the new name, is that the process can be automated with relatively minor amount of input thus potentially substantially reducing cost and time.

In some examples a corpus of interest can be used which has already been manipulated according to steps 10-20 for scoring words and the steps 30-40 for generating new words. For example, the corpus of words may have typicality as its characteristic of interest and a separate set of value scores for each of three sets of n-grams, 3-gram, 4-gram and 6-gram.

To use the n-grams to generate new words, a technique called beam search can be used. In this process, the most probable n-gram at every step is chosen, see step 42, 44 and 48 above, generating a new word as a sequence of n-grams. For example, say that the most probable 3-gram you have discovered at the start of a word is “̂an”. This becomes the beginning of your newly generated word. Now take the most probable 3-gram that is a possible continuation of “̂an”, say, “ant”. Perhaps “nti” is the most probable continuation of “ant”; select that 3-gram and now your word begins “anti.” Following through to the end, you might construct a word such as “antidone”, which is not a current word of English but looks very much like one. To generate additional words, instead of choosing the single most probably 3-gram at each step, choose the most probable 10, or 100, and follow through each of the resulting paths.

The foregoing demonstrates how to score a word for how typically English it appears or sounds. To look at more nuanced characteristics of words, additional models can be constructed on the basis of existing words that exhibit a characteristic of interest other than or in addition to typicality. For example, assume it is desired to score words for how much they connote the idea of “light,” so that “light” is the characteristic of interest. The corpus of words with the selected characteristic of interest, that is “light”, is created and accessed, or simply accessed if it already exists. One way to create a corpus of words with “light” as the characteristic of interest is to take all the words in one or more appropriate dictionaries whose entries contain “light”. Alternatively, the corpus can be assembled by taking all the words that occur in some corpus of words, such as 20^{th}-century American novels, within 15 words of a use of “light.” Once we have the corpus of words exemplifying a characteristic of interest, we construct the model in the same way as the general English word list discussed above with regard to FIGS. 1 and 2. The basic difference is that this provides the probabilities of n-grams occurring within a corpus of light-related words, and can use that to score existing words for their “light”-ness, or to generate new words that might be expected to have connotations of light.

This same technique can be applied to any domain or characteristic for which a suitable wordlist can be found or constructed: car model names, words related to speed, words that sound tasty, scary words, Eastern-European surnames, etc. Multiple models can be combined by averaging the probabilities of their n-grams, so that we can generated a model that scores or generates words on the basis of how much they sound like a fast, reliable, sexy, American car, for example.

Other criteria can also be, so that it is possible to get, for example, results for fast, reliable, sexy, American car names that are 7 letters or less, start with a T, and are available as .com domains.

Models for different characteristics can be combined in the same way as models using different sub-word segments as described in the above paragraph starting with “As indicated above, . . . .” For example, to score words for how well they conjure the idea of a “fast, reliable, American car”, we can construct three separate models as described in the above seven paragraph starting with “In a method for scoring words, see FIG. 1, . . . ”: one for “fast”, one for “reliable”, and one for “American car”. Words can then be scored as to how well they reflect the combination of these characteristics by scoring the word according to each of the separate models, and then using some weighted average of the scores, depending on the mixture of the characteristics desired, the user can review the highly scored words in choosing, for example, a trademark for a new line of automobiles.

### Hardware

FIG. 3 is a simplified block diagram of a computer system 110 that can be used to implement aspects of the present invention.

Computer system 110 typically includes a processor subsystem 114 which communicates with a number of peripheral devices via bus subsystem 112. These peripheral devices may include a storage subsystem 124, comprising a memory subsystem 126 and a file storage subsystem 128, user interface input devices 122, user interface output devices 120, and a network interface subsystem 116. The input and output devices allow user interaction with computer system 110. Network interface subsystem 116 provides an interface to outside networks, including an interface to communication network 118, and is coupled via communication network 118 to corresponding interface devices in other computer systems. Communication network 118 may comprise many interconnected computer systems and communication links. These communication links may be wireline links, optical links, wireless links, or any other mechanisms for communication of information. While in one embodiment, communication network 118 is the Internet, in other embodiments, communication network 118 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 122 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 110 or onto computer network 118. Any one or more of the input devices can be used as parts of steps 10, 12, 30 and 32.

User interface output devices 120 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. The display subsystem may also provide non visual display such as via audio output devices. In general, use of the term “output device” is intended to include all possible types of devices and ways to output information from computer system 110 to the user or to another machine or computer system. Any one or more of the output devices can be used in providing words as discussed with respect to steps 28 and 54.

Storage subsystem 124 stores the basic programming and data constructs that provide the functionality of certain embodiments of the present invention. For example, the various modules implementing the functionality of certain embodiments of the invention may be stored in storage subsystem 124. These software modules are generally executed by processor subsystem 114. Storage subsystem 124 also preferably carries the corpus of words discussed above with respect to steps 14 and 34.

Memory subsystem 126 typically includes a number of memories including a main random access memory (RAM) 130 for storage of instructions and data during program execution and a read only memory (ROM) 132 in which fixed instructions are stored. File storage subsystem 128 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs, and may be stored by file storage subsystem 128. The host memory 126 contains, among other things, computer instructions which, when executed by the processor subsystem 114, cause the computer system to operate or perform functions as described herein. For example, computer instructions to perform steps 14-28 and 34-54 may be contained here. As used herein, processes and software that are said to run in or on “the host” or “the computer”, execute on the processor subsystem 114 in response to computer instructions and data in the host memory subsystem 126 including any other local or remote storage for such instructions and data.

Bus subsystem 112 provides a mechanism for letting the various components and subsystems of computer system 110 communicate with each other as intended. Although bus subsystem 112 is shown schematically as a single bus, alternative embodiments of the bus subsystem may use multiple busses.

Computer system 110 itself can be of varying types including a personal computer, a portable computer, a workstation, a computer terminal, a network computer, a television, a mainframe, a server farm, or any other data processing system or user device. Due to the ever changing nature of computers and networks, the description of computer system 110 depicted in FIG. 3 is intended only as a specific example for purposes of illustrating the preferred embodiments of the present invention. Many other configurations of computer system 110 are possible having more or less components than the computer system depicted in FIG. 3.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “indicate” is used herein to mean the same as “identify”.

Also as used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

The foregoing description of preferred embodiments of the present invention has been provided for the purposes of illustration and description. It is not intended to be exhaustive or to limit the invention to the precise forms disclosed. Many modifications and variations will be apparent to practitioners skilled in this art. In particular, and without limitation, any and all variations described, suggested or incorporated by reference in the Background section of this patent application are specifically incorporated by reference into the description herein of embodiments of the invention. In addition, any and all variations described, suggested or incorporated by reference herein with respect to any one embodiment are also to be considered taught with respect to all other embodiments. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for developing a database, such as a corpus of words, as described herein, systems including logic and resources to carry out such a method and/or support such a database, systems that take advantage of computer-assisted methods for developing or using such a database, media impressed with logic to carry out such methods and/or impressed with such a database itself, or computer-accessible services that carry out computer-assisted method described herein. It is contemplated that modifications and combinations will readily occur to those skilled in the art, which modifications and combinations will be within the spirit of the invention and the scope of the following claims.

I claim as follows:

1. A method for scoring a word according to a characteristic of interest, the method comprising the steps of:
a computer system accessing a corpus of words exemplifying a characteristic of interest, each word in the corpus of words having been broken into sub-word segments of a first type of sub-word segments, the number of times each sub-word segment being found in the corpus of words being stored as a first set of results, each sub-word segment having an associated value score based at least in part on the occurrence of the sub-word segment in the corpus of words, the value scores being stored as a second set of results;
breaking a word to be scored into the first type of sub-word segments;
determining the value score for each of the sub-word segments of the word to be scored based upon the second set of results;
using the value scores for each of the sub-word segments of the word to be scored to create a characteristic of interest score for the word to be scored; and
providing a user at least one word having an appropriate characteristic of interest score for use.

2. The method according to claim 1, further comprising accessing a corpus of words exemplifying typicality as the characteristic of interest.

3. The method according to claim 1, further comprising accessing a corpus of words in which the words have been broken into at least one n-gram type of sub-word segments.

4. The method according to claim 1, further comprising accessing a corpus of words in which the associated value score is a probability score.

5. The method according to claim 4, wherein the value scores using step comprises combining the probability scores for each of the sub-word segments of the word to be scored to create the characteristic of interest score.

6. The method according to claim 4, wherein the value scores using step comprises averaging the probability scores for each of the sub-word segments of the word to be scored to create the characteristic of interest score.

7. The method according to claim 1, wherein:
the corpus of words accessing step comprises accessing a corpus of words in which each word in the corpus of words has been broken into first and second types of sub-word segments;
the word breaking step is carried out by breaking said word to be scored into each of the first and second types of sub-word segments;
the value score determining step is carried out by determining the value score for each of the sub-word segments of the word to be scored for each of the first and second types of sub-word segments based upon the second set of results;
the values scores using step is carried out by using the value scores for each of the sub-word segments of the word to be scored for each of the first and second types of sub-word segments to create first and second characteristic of interest scores for the word to be scored; and further comprising:
using the first and second characteristic of interest scores to create a combined characteristic of interest score.

8. The method according to claim 1, further comprising naming a product using said at least one word having an appropriate characteristic of interest score.

9. The method according to claim 8, wherein the product naming step further comprises applying said at least one word to at least one of the product, packaging associated with the product.

10. A method for scoring words according to a characteristic of interest, the method comprising the steps of:
select a characteristic of interest; and
use a computer system to:
access a corpus of words exemplifying the characteristic of interest;
break each word in the corpus of words into sub-word segments of a first type of sub-word segments;
determine how many times each sub-word segment is found in the corpus of words and store the results as a first set of results;
generate a value score for each sub-word segment based at least in part on the occurrence of the sub-word segment in the corpus of words and store the results as a second set of results;
break a first word into the first type of sub-word segments;
determine the value score for each of the sub-word segments of the first word based upon the second set of results;
use the value scores for each of the sub-word segments of the first word to create a characteristic of interest score for the first word; and
provide at least one word having an appropriate characteristic of interest score for use.

11. The method according to claim 9, further comprising:
naming a product using said at least one word having an appropriate characteristic of interest score and;
using said at least one word as at least a part of a trademark applied to a product.

12. A system for scoring words according to a characteristic of interest, the system comprising:
a memory;
a data processor coupled to the memory, the data processor configured to:
access a corpus of words exemplifying the characteristic of interest;
break each word in the corpus of words into sub-word segments of a first type of sub-word segments;
determine how many times each sub-word segment is found in the corpus of words and store the results as a first set of results;
generate a value score for each sub-word segment based at least in part on the occurrence of the sub-word segment in the corpus of words and store the results as a second set of results;
break a first word into the first type of sub-word segments;
determine the value score for each of the sub-word segments of the first word based upon the second set of results;
use the value scores for each of the sub-word segments of the first word to create a characteristic of interest score for the first word; and
provide at least one word having an appropriate characteristic of interest score for use.

13. A method for generating new words according to a characteristic of interest, the method comprising the steps of:
a computer system accessing a corpus of words exemplifying a characteristic of interest, each word in the corpus of words having been broken into sub-word segments of a first type of sub-word segments, the number of times each sub-word segment being found in the corpus of words being stored as a first set of results, each sub-word segment having an associated value score based at least in part on the occurrence of the sub-word segment in the corpus of words, the value scores being stored as a second set of results;
choosing a number of first sub-word segments based at least in part upon their value scores;
combining at least one additional sub-word segment with the first sub-word segments based at least in part upon the first value scores for the at least one additional sub-word segments to create a set of potential new words;
generating a second value score for each of the potential new words;
selecting a new word from the potential new words based at least in part on the second value scores; and
providing a user said new word for use.

14. The method according to claim 13, further comprising accessing a corpus of words exemplifying typicality as the characteristic of interest.

15. The method according to claim 13, further comprising accessing a corpus of words in which the words have been broken into at least one n-gram type of sub-word segments.

16. The method according to claim 13, further comprising accessing a corpus of words in which the associated value score is a probability score.

17. The method according to claim 16, wherein the second value score generating step comprises combining the probability scores for the sub-word segments for each of the potential new words.

18. The method according to claim 16, wherein the second value score generating step comprises averaging the probability scores for the sub-word segments for each of the potential new words.

19. The method according to claim 13, wherein:
the corpus of words accessing step comprises accessing a corpus of words in which each word in the corpus of words has been broken into first and second types of sub-word segments;
the word breaking step is carried out by breaking said word to be scored into each of the first and second types of sub-word segments;
the value score determining step is carried out by determining the value score for each of the sub-word segments of the word to be scored for each of the first and second types of sub-word segments based upon the second set of results;
the values scores using step is carried out by using the value scores for each of the sub-word segments of the word to be scored for each of the first and second types of sub-word segments to create first and second characteristic of interest scores for the word to be scored; and further comprising:
using the first and second characteristic of interest scores to create a combined characteristic of interest score.

20. The method according to claim 13, further comprising naming a product using said new word.

21. The method according to claim 20, wherein the product naming step further comprises applying said new word to at least one of the product, packaging associated with the product.

22. A method for generating new words according to a characteristic of interest, the method comprising:
select a characteristic of interest; and
use the computer to:
access a corpus of words exemplifying a characteristic of interest;
break each word in the corpus of words into n-gram type of sub-word segments;
determine how many times n-gram is found in the corpus of words and store the results as a first set of results;
generate a first value score for each n-gram based at least in part on the occurrence of the n-gram occurs in the corpus of words and store the results as a second set of results;
choose a number of first sub-word segments based at least in part upon their value scores;
combine at least one additional sub-word segment with the first sub-word segments based at least in part upon the first value scores for the at least one additional sub-word segments to create a set of potential new words;
generate a second value score for each of the potential new words;
select a new word from the potential new words based at least in part on the second value scores; and
provide a user said new word for use.

23. The method according to claim 22, further comprising:
naming a product using said new word; and
using said new word as at least a part of a trademark applied to a product.

24. A system for scoring words according to a characteristic of interest, the method comprising the steps of:
a memory;
a data processor coupled to the memory, the data processor configured to:
access a corpus of words exemplifying a characteristic of interest;
break each word in the corpus of words into n-gram type of sub-word segments;
determine how many times n-gram is found in the corpus of words and store the results as a first set of results;
generate a first value score for each n-gram based at least in part on the occurrence of the n-gram occurs in the corpus of words and store the results as a second set of results;
choose a number of first sub-word segments based at least in part upon their value scores;
combine at least one additional sub-word segment to the first sub-word segments based at least in part upon the first value scores for the at least one additional sub-word segments to create a set of potential new words;
generate a second value score for each of the potential new words;
select a new word from the potential new words based at least in part on the second value scores; and
provide a user said new word for use.
